(19) United States
(12) Patent Application Publication
(10) Pub. No.: US 2011/0043480 A1
(43) Pub. Date: Feb. 24, 2011

(54) MULTIPLE INPUT ANALOG RESISTIVE TOUCH PANEL AND METHOD OF MAKING SAME

(75) Inventors: David Popovich, Calgary (CA); Bal Soora, Calgary (CA); Robbie Rattray, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART Technologies ULC, Calgary (CA)

(21) Appl. No.: 12/823,497

(22) Filed: Jun. 25, 2010

Related U.S. Application Data
(60) Provisional application No. 61/220,573, filed on Jun. 25, 2009.

(51) Int. Cl. G06F 3/045; G06F 3/044

(52) U.S. Cl. 345/174; 178/18.06

(57) ABSTRACT

A user input system comprises a top structure defining a touch surface. The top structure is disposed above and separated from a bottom structure by an air gap. Conductive resistive material is provided on facing surfaces of the upper and lower structures. The conductive resistive material on at least one of the upper and lower structures is configured to define at least a pair of electrically isolated resistive sheets. The top and bottom structures are moveable relative to one another in response to one or more contacts on the touch surface to bring the conductive resistive material on the top and bottom structures into contact adjacent each contact location.

### CROSS-REFERENCE TO RELATED APPLICATIONS

This application claims the benefit of U.S. Provisional Application No. 61/220,573 to Popovich, et al., filed on Jun. 25, 2009, the content of which is incorporated herein by reference in its entirety.

### FIELD OF THE INVENTION

The present invention relates generally to touch systems and in particular, to a multiple input analog resistive touch panel and method of making the same

### BACKGROUND OF THE INVENTION

Touch panels such as for example digitizers and analog resistive touch screens or panels that make use of one or more electrically resistive membranes, are known in the art. Analog resistive touch panels of this nature typically include an electrically resistive membrane that is positioned over and spaced from an electrically resistive substrate. Small spacers at spaced locations help to maintain the gap between the electrically resistive membrane and the electrically resistive substrate. When a pointer such as a finger or other suitable object is used to contact and apply pressure to the electrically resistive membrane with sufficient activation force, the electrically resistive membrane deflects and contacts the electrically resistive substrate thereby to make an electrical contact between the electrically resistive membrane and the substrate. Determining voltage changes induced by the electrical contact allows the position of pointer contact on the touch panel in (x,y) coordinates to be determined.

Many designs for analog resistive touch panels have been considered. For example, U.S. Pat. No. 5,838,309 to Robsky, et al. discloses a self-tensioning membrane touch screen that avoids the need for insulating spacer dots. The touch screen includes a support structure having a base and a substrate support on which a conductive surface is disposed. A peripheral insulating rail surrounds the conductive surface. A peripheral flexible wall extends upwardly from the base. A conductive membrane is stretched over the conductive surface and is attached to the peripheral flexible wall. The insulating rail acts to space the conductive membrane from the conductive surface. To inhibit sagging and maintain tension on the conductive membrane, once the conductive membrane has been attached to the flexible wall, the flexible wall is biased outwardly and downwardly. As a result, tension is continuously applied to the conductive membrane by the flexible wall thereby to inhibit sagging of the conductive membrane.

U.S. Pat. No. 6,034,335 to Aufderheide, et al. discloses an analog touch screen, comprising a top transparent layer disposed over a bottom transparent layer. The top layer comprises a flexible sheet having a layer of a semiconductive ceramic coated on a lower face thereof. The bottom transparent layer comprises a substrate sheet having a thin layer of a semiconductive ceramic coated on an upper face thereof. A non-electrically conductive spacer is interposed between the top and bottom layers effective for spacing apart the layers of semiconductive ceramic except when the top layer is flexed by an external touch so that electrical contact occurs between the semiconductive layers at a location where the touch occurred. A noncontinuous, electrically conductive metallic film which in use does not form an appreciable amount of an insulating oxide covers at least one of the layers of semiconductive ceramic so that the film is interposed between the semiconductive layers during electrical contact caused by a touch. The metallic film is of a thickness effective to reduce the effects of repeated operation on contact resistance over many operating cycles of the touch screen without substantially varying the sheet resistance of the underlying semiconductive ceramic layer. Conductors are connected to the top and bottom layers for applying an electrical current to the semiconductive layers to determine the horizontal and vertical position of the external touch on the top layer.

U.S. Pat. No. 6,246,394 to Kalthoff, et al. discloses a touch screen digitizing system that includes a touch screen unit including a first resistive sheet with opposed x+ and x− terminals and a second resistive sheet with opposed y+ and y− terminals, and an analog to digital converter (ADC) having first and second reference input terminals. A first switch is coupled between a first reference voltage and the x− terminal, and a second switch is coupled between the x+ terminal and a second reference voltage for energizing the first resistive sheet. A third switch is coupled between the first reference voltage and the y− terminal, and a fourth switch is coupled between the y+ terminal and the second reference voltage for energizing the second resistive sheet. Switching circuitry couples an input of the ADC to the y+ terminal while the first resistive sheet is energized and the second resistive sheet is not energized, and also couples the input to the x+ terminal while the second resistive sheet is energized and the first resistive sheet is not energized.

U.S. Pat. No. 6,664,950 to Blanchard discloses a resistive touch panel having a removable, top plate and a base plate. The touch panel may be situated relative to a display screen such that an air gap exists between the base plate and the display screen. The top plate includes a transparent, flexible substrate having a hard transparent coating, one or more anti-reflective coatings and an anti-fingerprint coating thereon. The underside of the substrate is spaced from the upper surface of the base plate by an air gap. To prevent wrinkling of the top plate, a stiff frame is bonded to the anti-fingerprint coating. The stiff frame maintains tension in the top plate despite temperature changes.

U.S. Patent Application Publication No. 2008/0083602 to Auger, et al., assigned to SMART Technologies ULC, assignee of the subject application, the content of which is incorporated herein by reference, discloses a touch panel comprising a support structure having a substrate with a generally planar conductive surface disposed thereon and an insulating spacer generally about the periphery of the substrate. A conductive member overlies the support structure. The spacer separates the conductive membrane and the conductive surface thereby to define an air gap therebetween. A conductive membrane is secured to the support structure under sufficient tension to inhibit slack from developing in the conductive membrane as a result of changes in environmental conditions.

Although these analog resistive touch panels work satisfactory, their designs only permit one user to interact with the touch panels at any given time. In many environments, multiple user capability is desired or required. As a result improvements in analog resistive touch panels are desired. It is therefore an object of the present invention to provide a novel multiple input analog resistive touch panel and method of making the same.

### SUMMARY OF THE INVENTION

Accordingly, in one aspect there is provided a user input system comprising a top structure defining a touch surface, said top structure being disposed above and separated from a bottom structure by an air gap; and conductive resistive material on facing surfaces of said upper and lower structures, the conductive resistive material on at least one of said upper and lower structures being configured to define at least a pair of electrically isolated resistive sheets, wherein said top and bottom structures are moveable relative to one another in response to one or more contacts on said touch surface to bring the conductive resistive material on said top and bottom structures into contact adjacent each contact location.

In one embodiment, the conductive resistive material on only one of the upper and lower structures is configured to define at least a pair of electrically isolated resistive sheets and the conductive resistive material on the other of the upper and lower structures is configured to define a single resistive sheet. Each isolated resistive sheet may be of substantially the same size and shape or may be of different sizes and/or shapes.

In one embodiment, the top structure comprises at least one layer of flexible material and at least two electrically isolated conductive resistive layers on the at least one flexible layer that face the bottom structure. The bottom structure in this case comprises a substrate and a single conductive resistive layer on the substrate that faces the electrically isolated conductive resistive layers on the at least one flexible layer. In another embodiment, the bottom structure comprises a substrate and at least two electrically isolated conductive resistive layers on the substrate that face the top structure. The top structure in this case comprises at least one sheet of flexible material and a single conductive resistive layer on the at least one flexible sheet that faces the electrically isolated conductive resistive layers on the substrate.

In the above embodiments, filler material may extend between the top and bottom structures at least at locations corresponding to regions of electrical isolation of the electrically isolated resistive sheets.

In yet another embodiment, the top structure comprises at least two separate isolated layers of flexible material and an electrically isolated conductive resistive layer on each flexible layer that faces the bottom structure. In this case, the bottom structure comprises a substrate and a single conductive resistive layer on the substrate that faces the electrically isolated conductive resistive layer on the flexible layers. Filler material may bridge the isolated flexible layers and extend to the bottom structure.

According to another aspect there is provided a method of detecting the position of a pointer relative to a touch surface on an analog resistive input device comprising at least two independent input areas capable of being probed independently, comprising:
equentially probing each sheet to detect the existence of a touch event; and if a touch event exists, determining the location of the touch event.

In one embodiment, during the probing, if a touch event exists on a sheet, the location of the touch event on that sheet is determined before the next sheet is probed.

According to yet another aspect there is provided an analog resistive input device comprising top and bottom structures separated by an air gap and moveable relative to one another to establish contact therebetween, the top and bottom structures being configured to define at least two independent input areas.

In one embodiment, the independent input areas are arranged either side-by-side or top-to-bottom.

### BRIEF DESCRIPTION OF THE DRAWINGS

Embodiments will now be described more fully with reference to the accompanying drawings in which:

FIG. 1 is a front elevational view of a conventional prior art analog resistive touch panel.

FIG. 2 is a cross-sectional view of the touch panel of FIG. 1 taken along line 2-2.

FIG. 3 is a schematic illustration of a top layer of the touch panel of FIG. 1.

FIG. 4 is a schematic illustration of a bottom layer of the touch panel of FIG. 1.

FIG. 5 is a schematic illustration, partly in section, of the touch panel of FIG. 1.

FIG. 6 is a front elevational view of a multiple input analog resistive touch panel.

FIG. 7 is a cross-sectional view of the touch panel of FIG. 6 taken along line 7-7.

FIG. 8 is a schematic illustration of a top layer of the touch panel of FIG. 6.

FIG. 9 is a schematic illustration of a bottom layer of the touch panel of FIG. 6.

FIG. 10 is another cross-sectional view of the touch panel of FIG. 6.

FIGS. 11 to 14 are cross-sectional views of the touch panel of FIG. 6 showing movement of a pointer across the touch surface of the touch panel.

FIGS. 15 to 18 are cross-sectional views of the touch panel of FIG. 6 showing movement of an alternative pointer across the touch surface of the touch panel.

FIGS. 19 and 20 show pointer coordinates on the touch surface of the touch panel of FIG. 6.

FIG. 21 is a cross-sectional view of an alternative multiple input analog resistive touch panel.

### DETAILED DESCRIPTION OF THE PREFERRED EMBODIMENTS

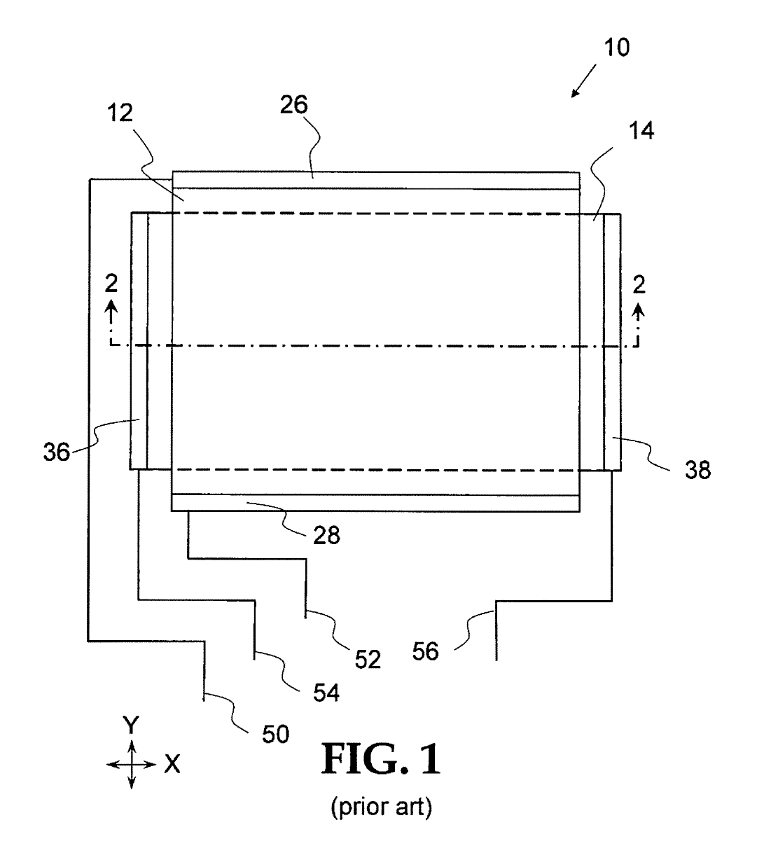

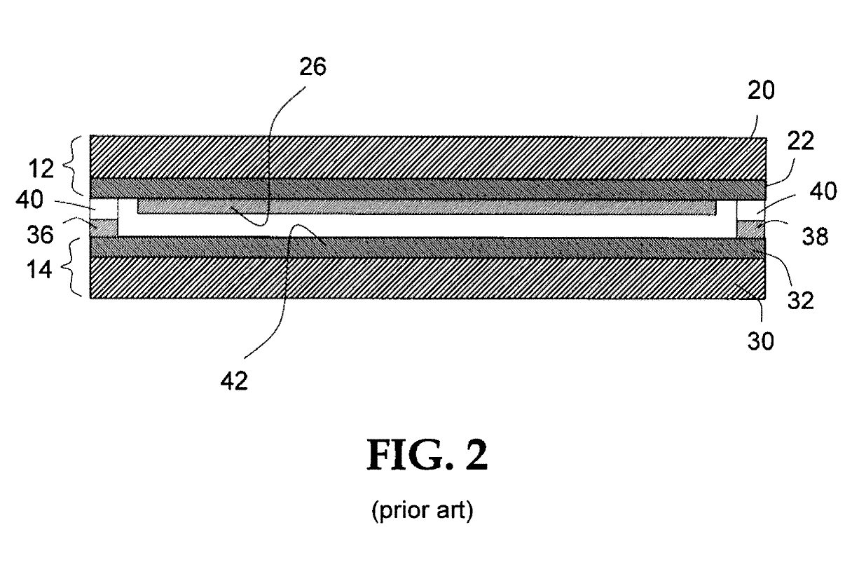

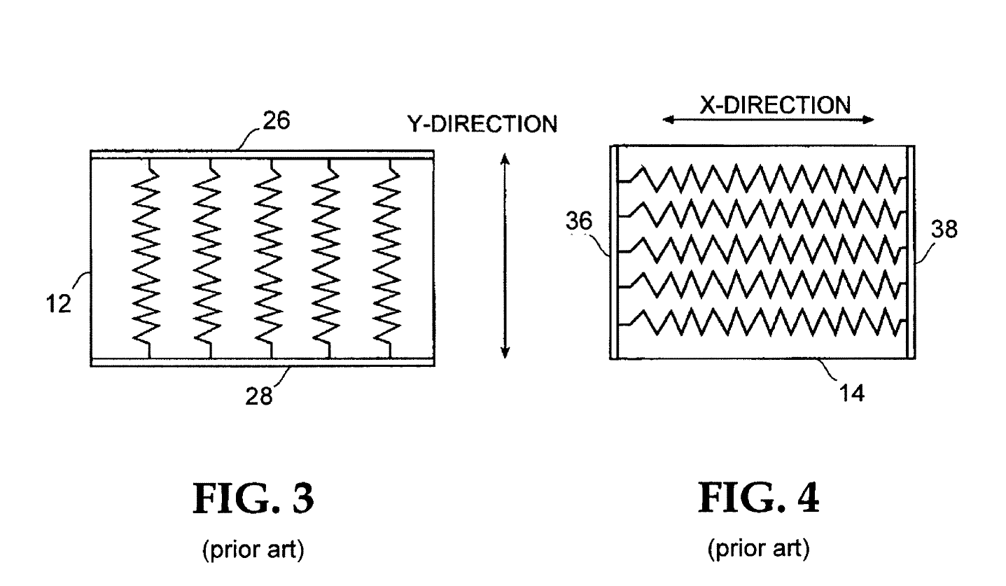

For ease of understanding, a prior art analog resistive touch panel and its operation will firstly be described with reference to FIGS. 1 to 5. Turning now to these figures, a conventional analog resistive touch panel is shown and is generally identified by reference numeral 10. As can be seen, touch panel 10 comprises a generally rectangular top structure 12 disposed over a generally rectangular rectangular bottom structure 14. The top structure 12 defines a touch surface for the touch panel 10. The top structure 12 comprises an upper, flexible continuous layer or sheet 20 formed of polyester or other suitable material and a rectangular resistive layer or film 22 sputtered on or otherwise applied to one side of the sheet 20. In this embodiment, the resistive film 22 is formed of indium tin oxide (ITO) and defines a continuous resistive sheet. The resistive film 22 typically has a resistance in the range of from about 60 ohms to about 500 ohms. Bus bars 26 and 28 extend along the upper and lower sides of the top structure 12 and are electrically connected to the resistive film 22. The bus bars 26 and 28 in this embodiment are formed of silver-particle filled polymer, thick film conductive ink.

The bottom structure 14 comprises a substrate 30 formed of polyester or other suitable material and a rectangular resistive layer or film 32 sputtered on or otherwise applied to one side of the substrate 30. The resistive film 32 is also formed of indium tin oxide (ITO) and defines a continuous resistive sheet. The resistive films 22 and 32 are of generally uniform resistivity. Bus bars 36 and 38 extend along the left and right sides of the bottom layer 14. The bus bars 36 and 38 are also formed of silver-particle filled polymer, thick film conductive ink. The conductive ink forming the bus bars 26, 28, 36 and 38 is selected to exhibit a conductivity that is about 1000 times greater than the conductivity of the ITO resistive films 22 and 32.

A spacer 40 formed of adhesive acts between the top and bottom structures 12 and 14 adjacent their peripheral edges to secure the top and bottom structures together while maintaining an air gap 42 between the top and bottom structures 12 and 14. Conductors 50 and 52 extend from the bus bars 26 and 28 and lead to well known decoding circuitry (not shown) such as that described in U.S. Pat. No. 6,246,394 to Kalthoff, et al. Conductors 54 and 56 extend from the bus bars 36 and 38 and also lead to well known decoding circuitry (not shown).

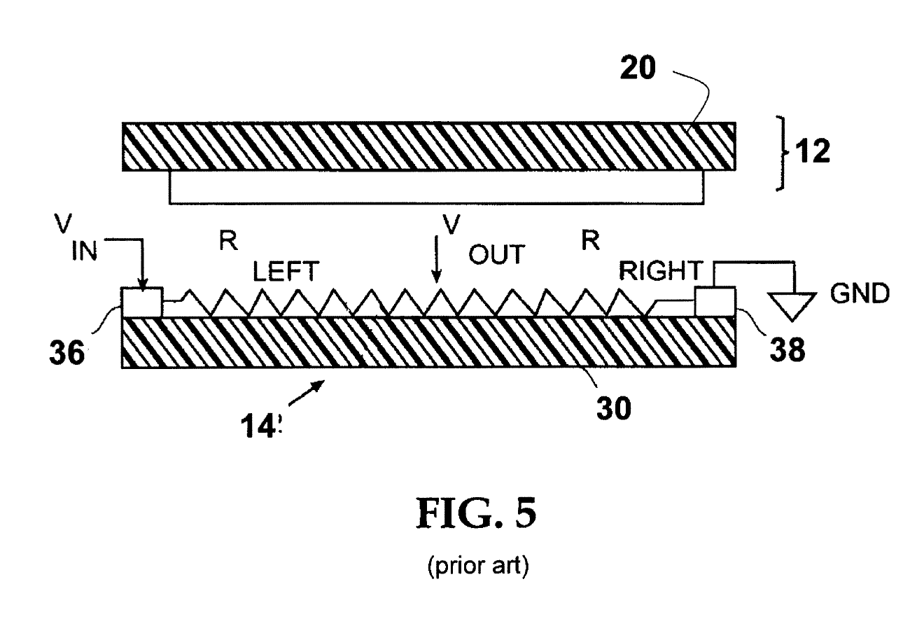

During operation of the touch panel 10, a voltage gradient Vin is initially applied across one of the top and bottom structures 12 and 14, in this example, the bottom structure 14. In particular, a voltage source is connected to the bus bar 36 while the bus bar 38 is connected to ground as shown in FIG. 5 resulting in a voltage gradient in the X-direction being developed across the ITO resistive film 32. When pressure is applied to the top structure 12 with sufficient activation force to bring the top and bottom structures 12 and 14 together, the ITO resistive film 22, adjacent the contact point, contacts the ITO resistive film 32. The point of contact is represented by the vertical arrow marked Vout.

The resistance of the ITO resistive film 32 between the point of contact Vout and the bus bar 38 is represented by Rright, and the resistance of the ITO resistive film 32 between the point of contact Vout and the bus bar 36 is represented by Rleft. The ratio of the voltage measured between the point of contact Vout and the grounded bus bar 38 to the voltage gradient Vin is equal to the ratio of the resistance Rright to the total resistance Rright+Rleft. Thus, the top and bottom structures 12 and 14 act as a voltage divider circuit. The decoding circuitry that is electrically connected to the bus bars 26 and 28 via the conductors 50 and 52 probes the ITO resistive film 22 and generates a resultant value that represents the X-coordinate of the contact point Vout on the touch surface of the touch panel 10 as a result of the contact of ITO resistive film 22 with the biased ITO resistive film 32.

With the X-coordinate known, the voltage gradient Vin is applied across the top structure 12 by connecting the voltage source to the bus bar 26 and connecting the bus bar 28 to ground. This results in a voltage gradient in the Y-direction being developed across the ITO resistive film 22. The decoding circuitry that is electrically connected to the bus bars 36 and 38 via the conductors 54 and 56 probes the ITO resistive film 32 and generates a resultant value that represents the Y-coordinate of the contact point Vout on the touch surface of the touch panel 10 as a result of the contact of ITO resistive film 32 with the biased ITO resistive film 22.

Typically, the touch panel is connected to a general purpose computing device, such as for example a personal or laptop computer, executing one or more application programs. The coordinate output of the touch panel 10 is conveyed to the general purpose computing device which uses the coordinate output to update the running application program. The display output of the general purpose computing device is in turn projected onto the touch surface of the touch panel 10 allowing a user to interact with the general purpose computing device display via contact with the touch surface.

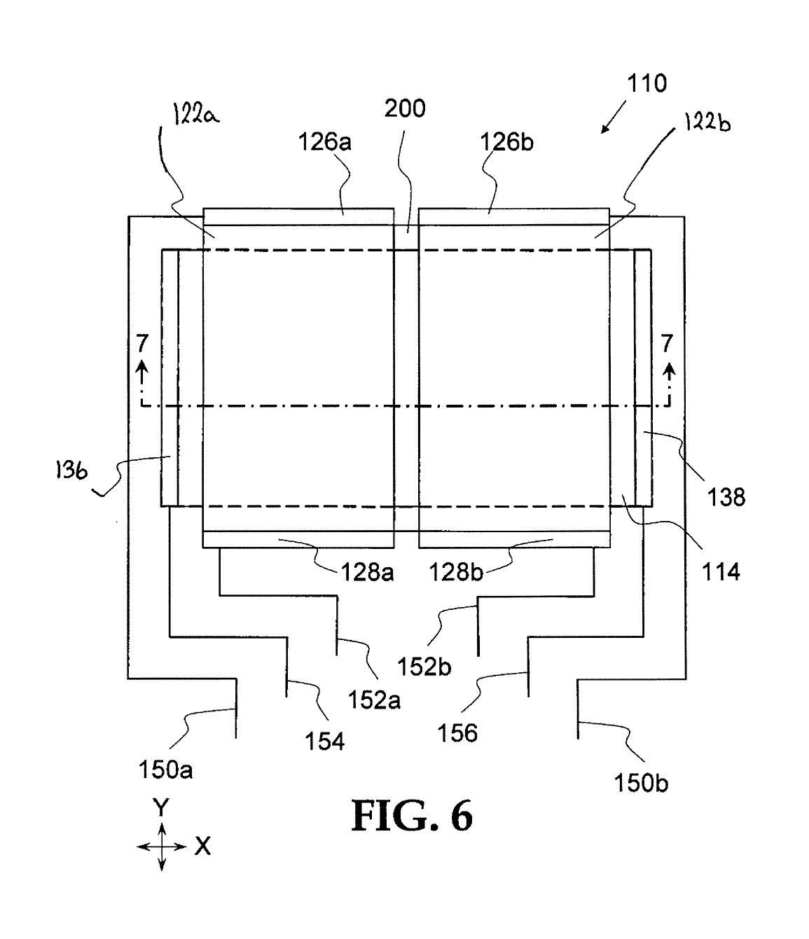

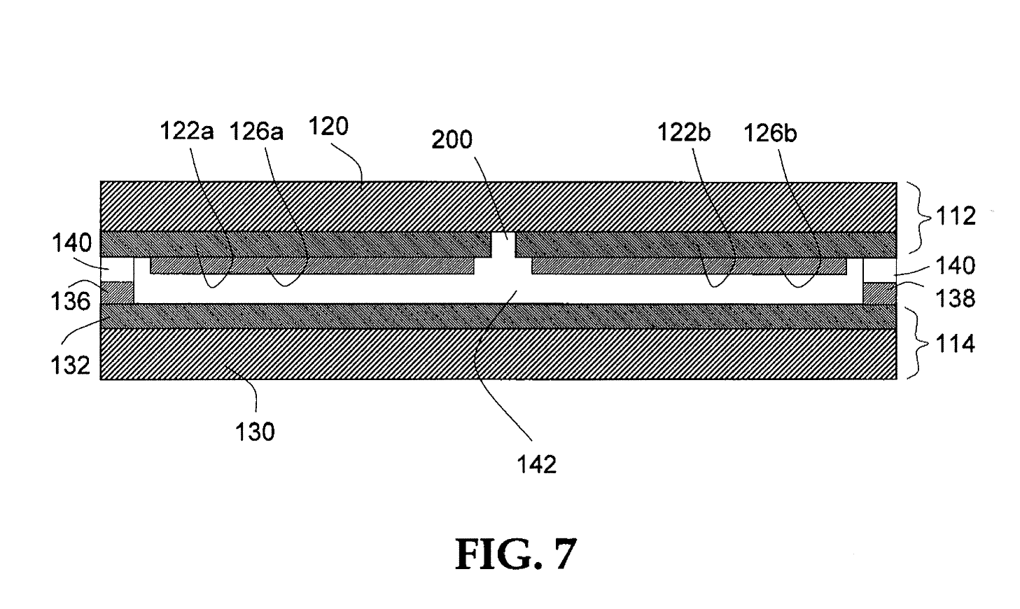

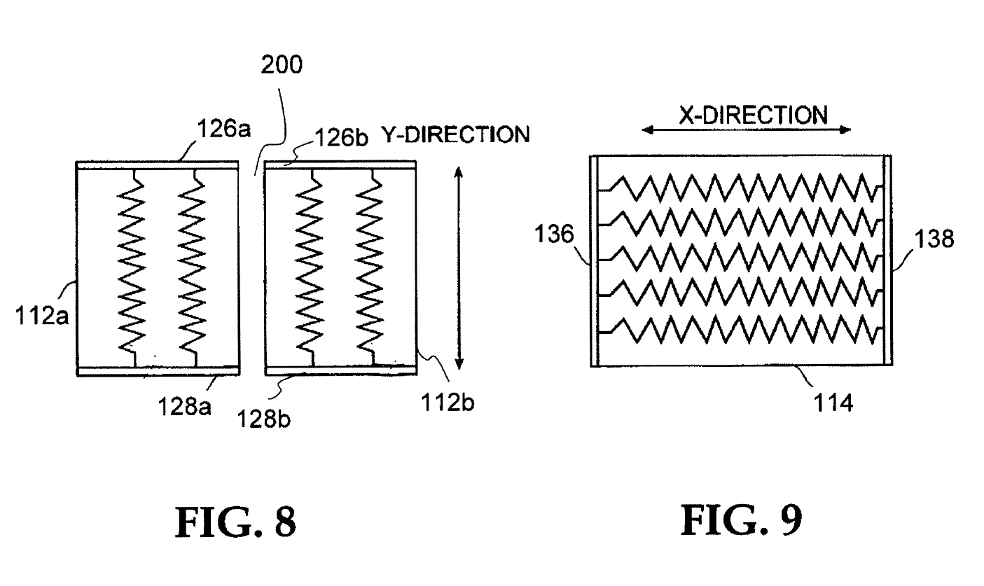

Turning now to FIGS. 6 to 10, a multiple input analog resistive touch panel that is used in a similar environment is shown and is generally identified by reference numeral 110. As can be seen, touch panel 110 comprises a top structure 112 defining a touch surface for the touch panel 110 disposed over a bottom structure 114. The top structure 112 comprises an upper, flexible continuous layer or sheet 120 formed of polyester or other suitable material. A pair of side-by-side electrically insulated ITO resistive layers or films 122a and 122b separated by a gap 200 are sputtered on or otherwise applied to one side of the sheet 120. In this embodiment, the gap 200 between the ITO resistive films 122a and 122b is less than two-hundred (200) thousands of an inch. Each ITO resistive film 122a and 122b defines a continuous resistive sheet having a resistance in the range of from about 60 ohms to about 500 ohms. Bus bars 126a and 128a extend along the upper and lower sides of the ITO resistive film 122a and bus bars 126b and 128b extend along the upper and lower sides of the ITO resistive film 122b. The bus bars 126a, 128a, 126b and 128b in this embodiment are formed of silver-particle filled polymer, thick film conductive ink.

The bottom structure 114 comprises a substrate 130 formed of polyester or other suitable material and an ITO resistive layer or film 132 sputtered on or otherwise applied to one side of the substrate 130. The ITO resistive film 132 has a resistance in the range of from about 60 ohms to about 500 ohms. Bus bars 136 and 138 extend along the left and right sides of the bottom layer 114 and are electrically connected to the ITO resistive film 132. The bus bars 136 and 138 are also formed of silver-particle filled polymer, thick film conductive ink. The conductive ink forming the bus bars 126a, 126b, 128a, 128b, 136 and 138 is selected to exhibit a conductivity that is about 1000 times greater than the conductivity of the ITO resistive films 122a, 122b and 132.

A spacer 140 formed of adhesive acts between the top structure 112 and the bottom structure 114 adjacent the peripheral edges of the top and bottom structures to secure the top structure 112 and bottom structure 114 together while maintaining an air gap 142 between the ITO resistive films 122a and 122b and the ITO resistive film 132. Conductors 150a and 152a extend from the bus bars 126a and 128a and lead to well known decoding circuitry (not shown). Conductors 150b and 152b extend from the bus bars 126b and 128b and lead to well known decoding circuitry (not shown). Conductors 154 and 156 extend from the bus bars 136 and 138 and also lead to well known decoding circuitry (not shown).

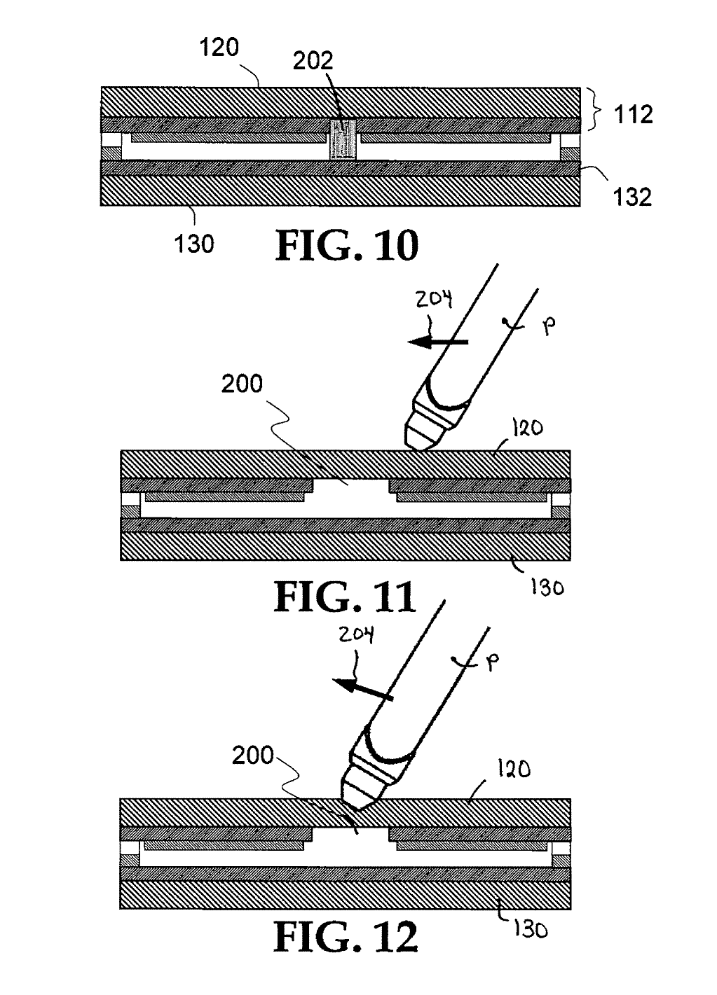

Non-electrically conductive filler material 202 (see FIG. 10) extends between the top structure 112 and the bottom structure 114 at the gap 200 between the ITO resistive films 122a and 122b thereby to give the touch panel 110 a contiguous touch surface so that a pointer moving across the touch panel 110 and over the gap 200 does so smoothly with a generally seamless transition.

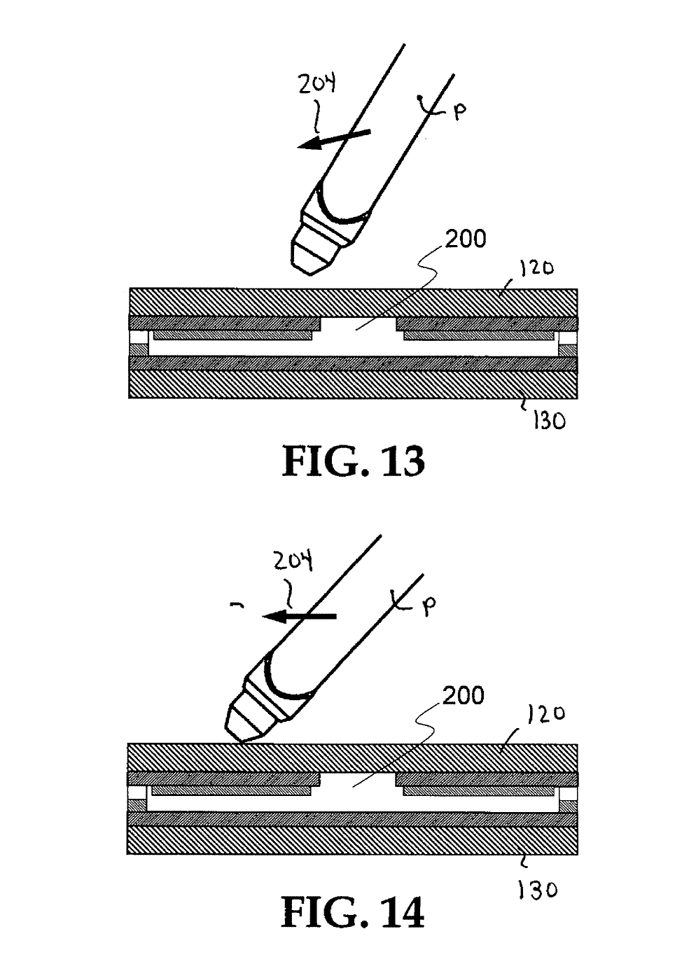

FIGS. 11 to 14 show a pointer P moving across the touch panel 110 and over the gap 200 between the ITO resistive films 122a and 122b in the absence of the filler material 202. As can be seen in FIG. 11, the pointer P is above ITO resistive film 122b and is moving across the sheet 120 in the direction of arrow 204 towards the gap 200. FIG. 12 shows the pointer P when the pointer P reaches the gap 200. During continued movement of the pointer P in the direction of arrow 204, the pointer P tends to bounce resulting in a loss of contact between the pointer P and the touch panel 110 as shown in FIG. 13. FIG. 14 shows the pointer P after it has been brought back into contact with the sheet 120 above the ITO resistive layer 122a. As will be appreciated, this loss of pointer contact with the touch panel 110 can result in undesired touch panel operation. For example, during an object drag event or a window re-size event, loss of pointer contact with the touch panel 110 may result in dropping of the object being manipulated.

During operation of the touch panel 110, a voltage gradient Vin in the Y-direction is initially applied across the ITO resistive film 122a and the ITO resistive film 132 is probed by the decoding circuitry to see if a pointer contact with the sheet 120 over the ITO resistive film 122a has been detected. If a pointer contact is detected, the position of the pointer contact is read out. If a pointer contact is not detected or after the position of such a pointer contact is read out, a voltage gradient Vin in the Y-direction is applied across the ITO resistive film 122b to see if a pointer contact with the sheet 120 over the ITO resistive film 122b has been detected. If a pointer contact is detected, the position of the pointer contact is read out.

During application of the voltage gradient Vin to the ITO resistive film 122a, a voltage source is connected to the bus bar 126a while the bus bar 128a is connected to ground. When pressure is applied to the top structure 112 over the ITO resistive film 122a with sufficient activation force to bring the top structure 112 and the bottom structure 114 together, the ITO resistive film 122a adjacent the contact point, contacts the ITO resistive film 132. The decoding circuitry that is electrically connected to the bus bars 136 and 138 via the conductors 154 and 156 probes the ITO resistive film 132 and generates a resultant value that represents the Y-coordinate of the contact point on the top structure 112 of the touch panel 110 as a result of the contact of ITO resistive film 132 with the biased ITO resistive film 122a.

After the Y-coordinate is known, a voltage gradient Vin in the X-direction is applied across the ITO resistive layer 132. The decoding circuitry that is electrically connected to the bus bars 126a and 128b via the conductors 150a and 152a probes the ITO resistive film 122a and generates a resultant value that represents the X-coordinate of the contact point on the touch panel 110 as a result of the contact of ITO resistive film 122a with the biased ITO resistive film 132.

A similar procedure is performed when a pointer contact on the sheet 120 over the ITO resistive film 122b is detected. As will be appreciated, as the two ITO resistive films 122a and 122b are separated by the gap 200 and thus remain electrically isolated, simultaneous contacts on the top structure 112 over the ITO resistive films 122a and 122b can be detected allowing multiple users to interact with the touch panel 110 simultaneously.

The touch panel 110 is typically connected to a general purpose computing device executing one or more application programs. The coordinate output of the touch panel 110 is conveyed to the general purpose computing device which uses the coordinate output to update the running application program. The display output of the general purpose computing device is in turn projected onto the touch surface of the touch panel 110 allowing a user to interact with the general purpose computing device display via contact with the touch surface. To facilitate use when an image is projected on the touch panel 110, the image typically includes a line coincident with the boundary between the separate touch regions defined by the electrically isolated conductive resistive films 122a and 122b to provide a visual cue of the existence of the different touch regions.

U.S. Pat. No. 7,289,113 to Martin, assigned to SMART Technologies ULC, assignee of the subject application, describes a method of calibrating an image on a touch panel. Keystoning caused by a misalignment between a projector and the touch panel as well as problems associated with rotation of the image on the touch panel and related issues are the primary problems overcome by this calibration procedure.

A touch board alignment procedure is typically employed to ensure that the image on the touch panel 110 corresponds with the image appearing on the display of the general purpose computing device connected to the touch panel 110. The purpose of this alignment procedure is to determine the position of the projected image on the touch panel 110 and to determine the corrections required to compensate for image projection problems.

To facilitate the calibration of a projected image on the touch panel 110, the bus bars 126a and 126b are electrically connected, and bus bars 128a and 128b are electrically connected, as previously described, to transform the dual input touch panel 110 into a single input touch panel. A well known multi-point calibration technique may then be performed to calibrate the image to the touch panel. Once calibrated, the electrical connections between the bus bars 126a and 126b and the bus bars 128a and 128b are removed.

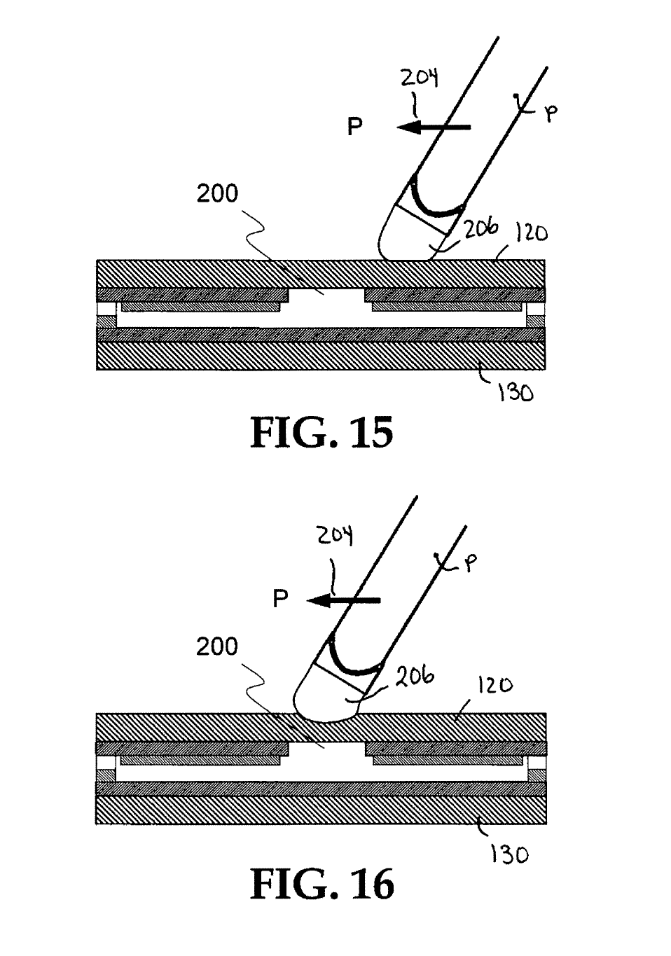

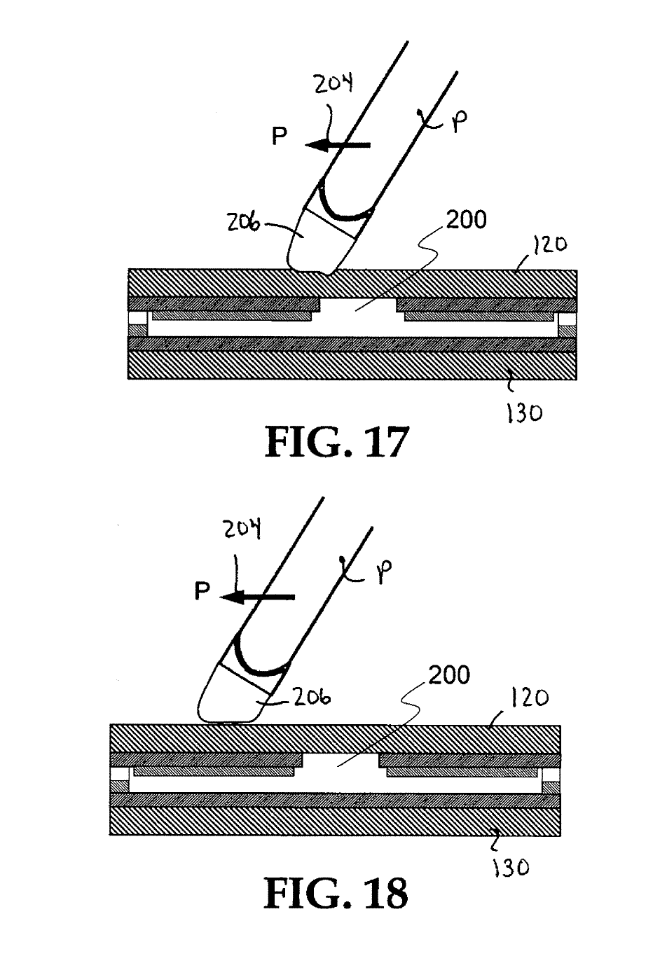

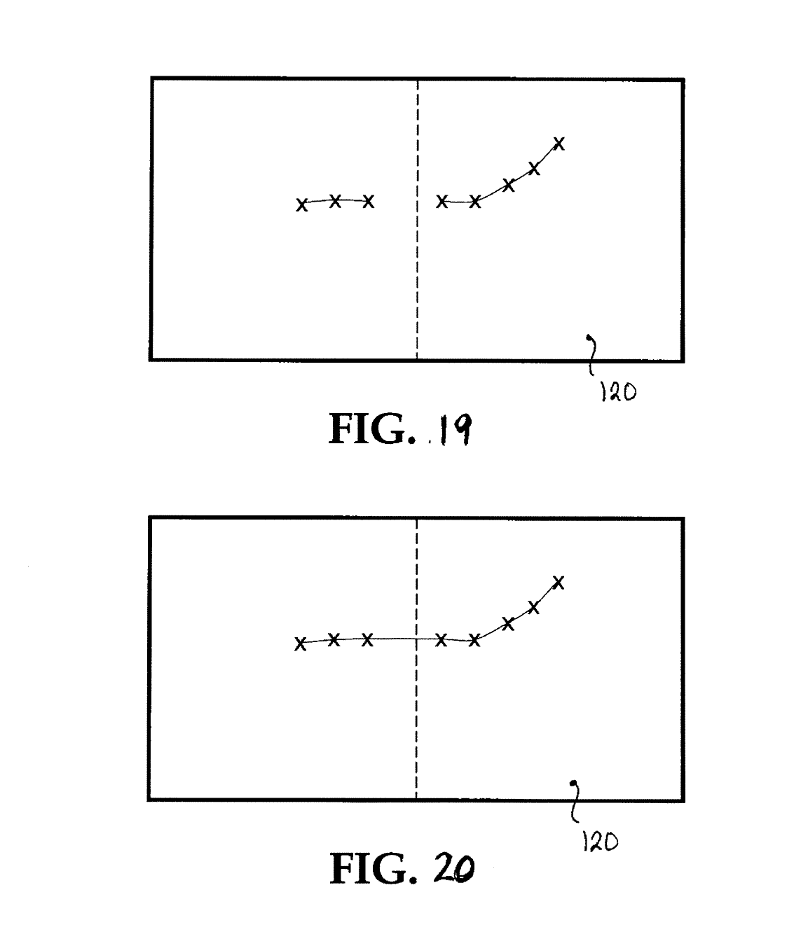

Rather than filling the gap 200 with filler material 202, the pointer P can be provided with a soft deformable nib 206 that absorbs energy when the pointer is moved across the gap 200 thereby to avoid bouncing of the pointer as shown in FIGS. 15 to 18. Of course if desired, software executed by the general purpose computing device can be used to fill in gaps in pointer coordinates that may occur as a result of pointer bouncing when the pointer is moved across the gap 200 as shown in FIGS. 19 and 20.

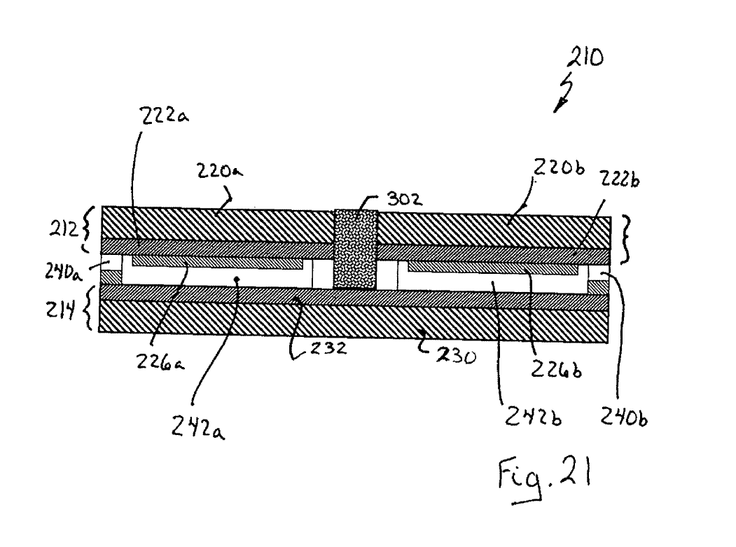

Turning now to FIG. 21, another embodiment of a multiple input touch panel is shown and is generally identified by reference numeral 210. In this embodiment, the touch panel 210 comprises a top structure 212 defining a touch surface for the touch panel disposed above a bottom structure 214. The top structure 212 comprises a pair of side-by-side rectangular layers or sheets 120a and 120b formed of polyester or other suitable material separated by a gap 300. An ITO resistive layer or film 222a is sputtered on or otherwise applied to one side of the sheet 220a. The ITO resistive film 222a has a resistance in the range of from about 60 ohms to about 500 ohms. Bus bars 226a and 228a extend along the upper and lower sides of the ITO resistive film 222a. The bus bars 226a and 228a in this embodiment are formed of silver-particle filled polymer, thick film conductive ink.

An ITO resistive layer or film 222b is also sputtered on or otherwise applied to one side of the sheet 220b. The ITO resistive film 222b has a resistance in the range of from about 60 ohms to about 500 ohms. Bus bars 226b and 228b extend along the upper and lower sides of the ITO resistive film 222b. The bus bars 226b and 228b in this embodiment are formed of silver-particle filled polymer, thick film conductive ink.

The bottom structure 214 comprises a substrate 230 formed of polyester or other suitable material and an ITO resistive layer or film 232 sputtered on or otherwise applied to one side of the substrate 230. The ITO resistive film 232 has a resistive in the range of from about 60 ohms to about 500 ohms. Bus bars 236 and 238 extend along the left and right sides of the bottom layer 214 and are electrically connected to the ITO resistive film 232. The bus bars 236 and 238 are also formed of silver-particle filled polymer, thick film conductive ink. The conductive ink forming the bus bars 226a, 226b, 228a, 228b, 236 and 238 is selected to exhibit a conductivity that is about 1000 times greater than the conductivity of the ITO resistive films 222a, 222b and 232.

A spacer 240a formed of adhesive acts between the sheet 220a and the bottom structure 214 adjacent the peripheral edges of the sheet 220a to secure the sheet 220a and the bottom structure 214 together while maintaining an air gap 242a between the sheet 220a and bottom structure 214. A spacer 240b formed of adhesive also acts between the sheet 220b and the bottom structure 214 adjacent the peripheral edges of the sheet 220b to secure the sheet 220b and bottom structure 214 together while maintaining an air gap 242b between the sheet 220b and the bottom structure 214. Conductors (not shown) extend from the bus bars 226a, 226b, 228a, 228b, 236 and 236 and lead to well known decoding circuitry (not shown).

A non-electrically conductive material 302 is used to fill the gap 300 between the sheets 220a and 220b thereby to give the touch panel 210 a generally contiguous touch surface so that a pointer moving across the touch panel 210 and over the gap 300 between the sheets 220a and 220b does so smoothly with a generally seamless transition.

If desired, the decoding circuitry can be configured to allow the touch panels 110 and 210 to operate either in the multiple input mode as described above or in a single input mode similar to the prior art touch panel shown in FIGS. 1 to 5. In the single input mode, the decoding circuitry electrically ties bus bars 126a and 126b and bus bars 128a and 128b in the case of touch panel 110 and electrically ties bus bars 226a and 226b and bus bars 228a and 228b in the case of touch panel 210 thereby to electrically connect the normally electrically isolated ITO resistive films. As a result, the ITO resistive films act as a single ITO resistive film.

In the embodiments described above, the input areas of the separate touch regions are shown as being rectangular, generally equal in size and side-by-side. Those of skill in the art will appreciate however, that the separate touch regions may be of different sizes and shapes and may be arranged top-to-bottom.

Although the substrate is described as being flexible, a rigid substrate formed for example of glass or other suitable material may be employed. Also, although the resistive films are described as being formed of ITO, other semiconductor coatings such as for example, tin oxide may be employed.

In the embodiments described above, the top structures are described as comprising a flexible layer or sheet having a resistive layer or film thereon. Those of skill in the art will appreciate that the top structure may comprise two or more overlying flexible layers or sheets, with the lower layer in the stack carrying the resistive layer or film thereon. If desired, the top structures may be pre-tensioned as described in above-incorporated U.S. Patent Application Publication No. 2008/0083602 to Auger.

In the embodiments shown in FIGS. 6 to 21, the touch panels 110 and 210 include two separate input regions allow different users to interact with the touch panels simultaneously. This is achieved by providing the top structures with a pair of electrically isolated resistive films, each of which can be independently biased into contact with the resistive film on the bottom structures. If desired, more than two electrically isolated resistive layers or films can be provided on the top structures to provide the touch panel with more than two separate input regions. Also, those of skill in the art will appreciate that the configurations of the resistive films on the top and bottom structures may be reversed. In this case, the bottom structures comprise at least two electrically isolated resistive films and the top structures comprise a single resistive film.

The gap between the ITO resistive films 122a and 122b can be created in a number of ways. For example, a continuous ITO resistive film may initially be sputtered on or otherwise applied to the sheet. A non-conductive break in the ITO resistive film may then be formed either by mechanically cutting the ITO resistive film using a knife or other suitable object or by using a suitable ablation technique. Alternatively a strip of removable tape may be applied to the sheet prior to application of the continuous ITO resistive layer. In this case, after the ITO resistive layer has been placed on the sheet and over the strip of tape, the strip of tape can be removed from the sheet thereby to form the gap between the ITO resistive films. For the embodiment of FIGS. 21 and 22, the individual sheets 220a and 220b of the top structure 212 can be taped together and a continuous ITO resistive layer can be applied to the taped sheets. After the ITO resistive layer has been applied to the taped sheets, the tape can be removed resulting in separate sheets, each coated with the ITO resistive film. Of course, each ITO film can be individually applied either to the sheet 120 in the case of the touch panel of FIGS. 6 to 10 or the sheets 220a and 220b in the case of the touch panel of FIG. 21.

Although numeric values are provided for the size of the gap, the ohmic resistive of the films and the conductivity of the bus bars, those of skill in the art will appreciate that these values are exemplary.

Although a number of embodiments of the touch panel have been described and illustrated, those of skill in the art will appreciate that other variations and modifications may be made without departing from the spirit and scope thereof as defined by the appended claims.

What is claimed is:

1. A user input system comprising:
a top structure defining a touch surface, said top structure being disposed above and separated from a bottom structure by an air gap; and
conductive resistive material on facing surfaces of said upper and lower structures, the conductive resistive material on at least one of said upper and lower structures being configured to define at least a pair of electrically isolated resistive sheets, wherein said top and bottom structures are moveable relative to one another in response to one or more contacts on said touch surface to bring the conductive resistive material on said top and bottom structures into contact adjacent each contact location.

2. A user input system according to claim 1 wherein the conductive resistive material on only one of said upper and lower structures is configured to define at least a pair of electrically isolated resistive sheets and wherein the conductive resistive material on the other of said upper and lower structures is configured to define a single resistive sheet.

3. A user input system according to claim 2 wherein each isolated resistive sheet is substantially the same size.

4. A user input system according to claim 2 wherein each isolated resistive sheet has a different size.

5. A user input system according to claim 1 wherein the resistive sheets are generally rectangular in shape.

6. A user input system according to claim 2 wherein said top structure comprises at least one layer of flexible material and at least two electrically isolated conductive resistive layers on said at least one flexible layer that face said bottom structure.

7. A user input system according to claim 6 wherein said conductive resistive layers have a resistance in the range of from about 60 ohms to about 500 ohms.

8. A user input system according to claim 6 wherein the conductive resistive layers are separated by a gap.

9. A user input system according to claim 6 wherein said bottom structure comprises a substrate and a single conductive resistive layer on said substrate that faces the electrically isolated conductive resistive layers on said at least one flexible layer.

10. A user input system according to claim 9 wherein said conductive resistive layer on said substrate has a resistance in the range of from about 60 ohms to about 500 ohms.

11. A user input system according to claim 2 wherein said bottom structure comprises a substrate and at least two electrically isolated conductive resistive layers on said substrate that face said top structure.

12. A user input system according to claim 11 wherein said conductive resistive layers have a resistance in the range of from about 60 ohms to about 500 ohms.

13. A user input system according to claim 11 wherein the conductive resistive layers are separated by a gap.

14. A user input system according to claim 11 wherein said top structure comprises at least one sheet of flexible material and a single conductive resistive layer on said at least one flexible sheet that faces the electrically isolated conductive resistive layers on the substrate.

15. A user input system according to claim 14 wherein said single conductive resistive layer has a resistive in the range of from about 60 ohms to about 500 ohms.

16. A user input system according to claim 2 further comprising filler material between the top and bottom structures at least at locations corresponding to regions of electrical isolation of the electrically isolated resistive sheets.

17. A user input system according to claim 2 wherein said top structure comprises at least two separate isolated layers of flexible material and an electrically isolated conductive resistive layer on each flexible layer that faces said bottom structure.

18. A user input system according to claim 17 wherein said conductive resistive layers have a resistance in the range of from about 60 ohms to about 500 ohms.

19. A user input system according to claim 17 wherein the conductive resistive layers and the flexible layers are separated by a gap.

20. A user input system according to claim 17 wherein said bottom structure comprises a substrate and a single conductive resistive layer on said substrate that faces the electrically isolated conductive resistive layers on said flexible layers.

21. A user input system according to claim 20 wherein said conductive resistive layer on said substrate has a resistance in the range of from about 60 ohms to about 500 ohms.

22. A user input system according to claim 17 further comprising filler material bridging the isolated flexible layers and extending to said bottom structure.

23. A user input system according to claim 1 further comprising bus bars in electrical communication with the resistive sheets.

24. A method of detecting the position of a pointer relative to a touch surface on an analog resistive input device comprising at least two independent input areas capable of being probed independently, comprising:
sequentially probing each sheet to detect the existence of a touch event; and
if a touch event exists, determining the location of the touch event.

25. The method of claim 24 wherein during said probing, if a touch event exists on a sheet, the location of the touch event on that sheet is determined before the next sheet is probed.

26. An analog resistive input device comprising top and bottom structures separated by an air gap and moveable relative to one another to establish contact therebetween, the top and bottom structures being configured to define at least two independent input areas.

27. An analog resistive input device according to claim 26 wherein the independent input areas are one of side-by-side and top-to-bottom.

28. An analog resistive input device according to claim 26 wherein the independent input areas are generally rectangular.

29. An analog resistive input device according to claim 26 wherein the independent areas are either the same size or are different sizes.
